(19) United States
(12) Patent Application Publication
(10) Pub. No.: US 2022/0398588 A1
(43) Pub. Date: Dec. 15, 2022

(54) IDENTIFYING AN UNAUTHORIZED DATA PROCESSING TRANSACTION

(71) Applicant: Bank of America Corporation, Charlotte, NC (US)

(72) Inventors: Kevin P. Thomsen, New York, NY (US); Sean C. Kowalski, Huntersville, NC (US); Srael Lee, Matthews, NC (US)

(21) Appl. No.: 17/347,076

(22) Filed: Jun. 14, 2021

(51) Int. Cl. G06Q 20/40; G06Q 20/38

(52) U.S. Cl. CPC G06Q 20/4016; G06Q 20/389; G06Q 20/405

(57) ABSTRACT

According to certain embodiments, a system comprises a memory and a processor operably coupled to the memory. The memory is operable to store historical data associated with previous data processing transactions, the historical data comprising a set of attributes, including an entity name attribute. The processor is configured to obtain the historical data and classify each previous data processing transaction as a member of a group of unauthorized previous data processing transactions or as a member of a group of authorized previous data processing transactions. The processor is further configured to determine a first pattern associated with the entity name attributes used by the members of the group of unauthorized previous data processing transactions, and to facilitate identifying a new data processing transaction as unauthorized based at least in part on an entity name attribute associated with the new data processing transaction using the first pattern.

### TECHNICAL FIELD

Certain embodiments of the present disclosure relate to identifying an unauthorized data processing transaction.

### BACKGROUND

A computer network may include nodes that use communication protocols to communicate over interconnections. The interconnections between the nodes may be arranged in a variety of network topologies, and the interconnections may be based on one or more network technologies, including wired and/or wireless technologies. Examples of nodes of a computer network may include personal computers, servers, networking hardware, or other specialized or general-purpose computers. A node may be identified by a hostname and a network address. A hostname serves as a memorable label for the node. A network address serves for locating and identifying the node by communication protocols, such as the Internet Protocol (IP). A computer network may support many applications and services. As an example, a computer network may support a data processing transaction.

### SUMMARY

The system disclosed in the present application provides a technical solution to the technical problems discussed above by leveraging machine learning to determine how to identify unauthorized data processing transactions so that the unauthorized data processing transactions can be blocked. The disclosed system provides several practical applications and technical advantages which include a process for classifying previous data processing transactions as authorized or unauthorized. This process provides a practical application by improving the network security of the system by allowing the system to identify one or more patterns associated with unauthorized previous data processing transactions, such as a pattern associated with entity name attributes used by the unauthorized previous data processing transactions. The system can use the one or more patterns to predict whether a subsequent data processing transaction is unauthorized. If, based on the one or more patterns, the system determines that the subsequent data processing transaction is unauthorized, the system can cause the subsequent data processing transaction to be blocked, for example, in order to protect data and devices within the network and to prevent a bad actor from performing malicious activities. Certain embodiments improve the speed and/or accuracy with which the system identifies and blocks the unauthorized data processing transactions, for example, by identifying the unauthorized data processing transactions based on matching new data processing transactions to one or more patterns associated with previous unauthorized data processing transactions.

These practical applications not only improve the network security of the system, they also improve the underlying network and the devices within the network. Blocking unauthorized data processing transactions may improve security of the network and the devices within the network and/or may allow for efficient use of the network and the devices within the network. When unauthorized data processing transactions occur, there may be an increase in the number of device resources consumed, which can degrade performance of the device. When unauthorized data processing transactions occur, there may be an increase in the number of network resources consumed, which reduces the throughput of the network. For example, unauthorized data processing transactions increase signaling across the network and consume network bandwidth. By preventing the unauthorized data processing transactions, the system is able to prevent unnecessary increases in the number of device resources, the number of network resources, and/or bandwidth resources that are consumed that would otherwise negatively impact the system. Thus, blocking unauthorized data processing transactions may facilitate efficient use of computing resources, such as network resources, processing resources, or memory resources because computing resources that would otherwise be required to transact the unauthorized data processing transaction may be conserved when the unauthorized data processing transaction is blocked.

In an embodiment, a system comprises a memory and a processor operably coupled to the memory. The memory is operable to store historical data associated with a plurality of previous data processing transactions. The historical data for each of the plurality of previous data processing transactions comprises a set of attributes. The set of attributes comprises an entity name attribute. The processor is configured to obtain the historical data and, for each previous data processing transaction of the plurality of previous data processing transactions, classify the previous data processing transaction as a member of a group of unauthorized previous data processing transactions or as a member of a group of authorized previous data processing transactions. The processor is further configured to determine a first pattern. The first pattern is associated with the entity name attributes used by the members of the group of unauthorized previous data processing transactions. The processor is further configured to facilitate identifying a new data processing transaction as unauthorized based at least in part on an entity name attribute associated with the new data processing transaction using the first pattern.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION

For a more complete understanding of the present disclosure and for further features and advantages thereof, reference is now made to the following description taken in conjunction with the accompanying example drawings, in which:

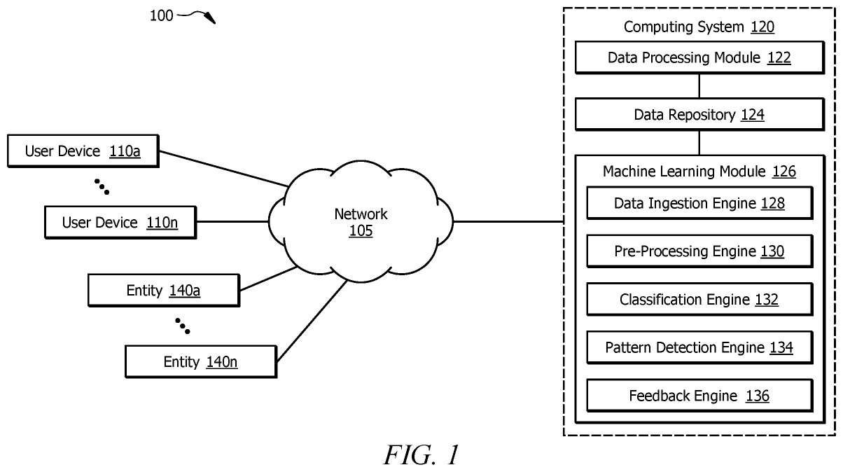

FIG. 1 illustrates an example of a system, in accordance with certain embodiments.

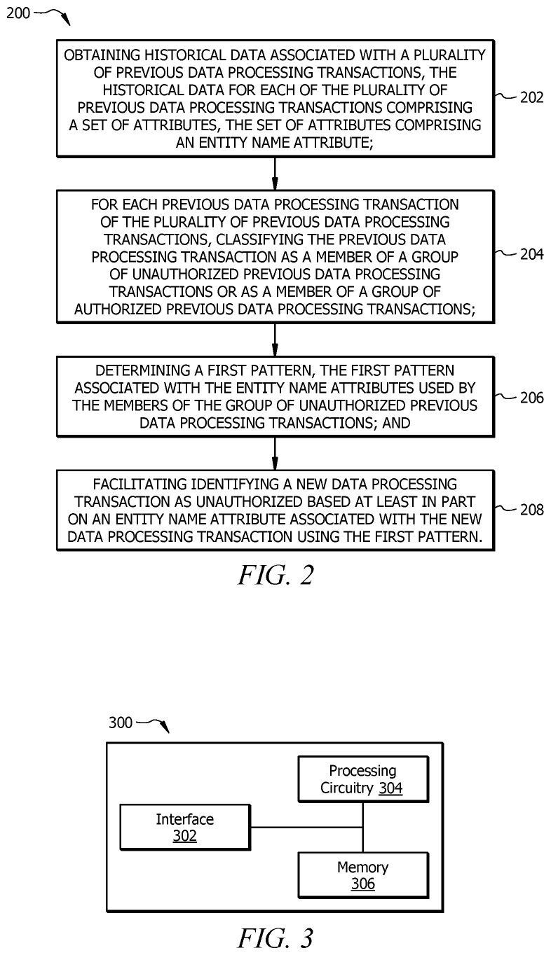

FIG. 2 illustrates an example of a method, in accordance with certain embodiments.

FIG. 3 illustrates an example of computing components, in accordance with certain embodiments.

### DETAILED DESCRIPTION

Certain embodiments of the present disclosure may be implemented in accordance with one or more of FIGS. 1-3, like numerals used to describe like components of the various figures.

FIG. 1 illustrates an example of system 100, in accordance with certain embodiments. According to certain embodiments, system 100 comprises a network 105 that facilitates communication among one or more user devices 110a-n, a computing system 120, and one or more entities 140a-n. In general, a user may interact with a user device 110 to request computing system 120 to facilitate a data processing transaction between user device 110 and an entity 140. Computing system 120 may determine whether the data processing transaction is authorized or unauthorized. In response to determining that the data processing transaction is authorized, computing system 120 may transact the data processing transaction. In response to determining that the data processing transaction is unauthorized, computing system 120 may block the transaction.

In certain embodiments, computing system 120 determines whether the data processing transaction is authorized or unauthorized based on comparing attributes of the data processing transaction to one or more patterns determined from previous data processing transactions. For example, computing system 120 obtains historical data associated with a plurality of previous data processing transactions. The historical data for each of the plurality of previous data processing transactions comprises a set of attributes. Examples of attributes may include an entity name attribute, an entity identifier attribute, an entity location attribute, a timestamp attribute, a transaction amount attribute, a transaction account attribute, and/or other attributes. For each previous data processing transaction of the plurality of previous data processing transactions, computing system 120 is operable to classify the previous data processing transaction as a member of a group of unauthorized previous data processing transactions or as a member of a group of authorized previous data processing transactions. Computing system 120 is further operable to determine one or more patterns based on the attributes used by the members of the group of unauthorized previous data processing transactions. Computing system 120 may then identify the data processing transaction requested by user device 110 as authorized if the attributes of the requested data processing transaction do not use the one or more patterns (e.g., if there are few similarities between the attributes of the requested data processing transaction and the one or more patterns), or computing system 120 may identify the requested data processing transaction as unauthorized if the attributes of the requested data processing transaction use the one or more patterns (e.g., if there are many similarities between the attributes of the requested data processing transaction and the one or more patterns).

Network 105 represents any suitable network(s) operable to facilitate communication between user device 110, computing system 120, and/or entity 140. Network 105 may include any interconnecting system capable of transmitting audio, video, signals, data, messages, or any combination of the preceding. Network 105 may include all or a portion of a public switched telephone network (PSTN), a cellular network, a base station, a gateway, a public or private data network, a local area network (LAN), a metropolitan area network (MAN), a wide area network (WAN), a wireless WAN (WWAN), a local, regional, or global communication or computer network, such as the Internet, a wireline or wireless network, an enterprise intranet, or any other suitable communication link, including combinations thereof, operable to facilitate communication between the components.

User device 110 generally refers to a computing device that can be used by the user to interact with computing system 120 and/or entity 140 via network 105. Examples include a workstation, a personal computer, a laptop, a tablet computer, a phone, a smartphone, a handheld device, a wireless device, etc.

Computing system 120 may comprise hardware and/or software capable of communicating with user device 110 and/or entity 140 via network 105. Examples of a computing system may include one or more servers (e.g., cloud-based servers, file servers, web servers, etc.), data centers, virtual machines, mainframe computers, etc.

In certain embodiments, computing system 120 comprises a data processing module 122, a data repository 124, and a machine learning module 126. In general, data processing module 122 transacts data processing transactions, data repository 124 stores data (including, e.g., historical data associated with the data processing transactions), and machine learning module 126 determines one or more patterns based at least in part on the historical data. In certain embodiments, machine learning module 126 comprises data ingestion engine 128, pre-processing engine 130, classification engine 132, pattern detection engine 134, and/or feedback engine 136.

Data ingestion engine 128 receives data used to train the machine learning module 126, such as historical data obtained from data repository 124. Pre-processing engine 130 translates the historical data into normalized datasets that can be processed by classification engine 132 and/or pattern detection engine 134. For example, in certain embodiments, functionality of pre-processing engine 130 may comprise formatting the historical data (which may include cleaning-up the data to be consistent with an expected format), arranging the historical data according to a pre-defined structure, associating the historical data with metadata (e.g., in certain embodiments, metadata may portions of the historical data that correspond to particular attributes), and/or other pre-processing.

Classification engine 132 may apply a classification algorithm that uses the normalized data to assign each of the previous data processing transactions to a respective class. The class may be the same or different for different previous data processing transactions, for example, depending on attributes that the previous data processing transactions do or do not have in common. Examples of classes include the group of unauthorized previous data processing transactions and the group of authorized previous data processing transactions.

Pattern detection engine 134 may apply rules, statistical analysis, and/or other techniques to determine one or more patterns that members of the same class tend to have in common with each other (and tend not to have in common with members of other classes). As an example, if pattern detection engine 134 detects the string “ZQXF” as frequently occurring in entity name attributes of unauthorized previous data processing transactions and rarely occurring in entity name attributes of authorized pervious data processing transactions, pattern detection engine 134 may determine that a pattern of unauthorized data processing transactions includes using the string “ZQXF” in an entity name attribute.

Feedback engine 136 may assess the accuracy of the patterns and may facilitate refining the patterns. For example, feedback engine 136 may compare a prediction made based on the one or more patterns against actual results in order to refine the machine learning over time. Thus, if feedback engine 136 determines that a pattern caused an authorized data processing transaction to be identified as unauthorized, or the pattern caused an unauthorized data processing transaction to be identified as authorized, feedback engine 136 may refine the pattern that led to the incorrect identification. Feedback engine 136 may determine the actual results in any suitable manner. As an example, in certain embodiments, an administrator of computing system 120 may provide input indicating the actual results. As another example, in certain embodiments, machine learning module 126 may continuously update the historical data as new data processing transactions are received, and feedback engine 136 may update the one or more patterns based on the updated historical data. Updating the one or more patterns may be performed by additional or different engines of machine learning module 126, depending on the embodiment.

Entity 140 may refer to an entity with which the user requests to transact the data processing transaction, for example, by interacting with user device 110 to send the request via computing system 120. In certain embodiments, entity 140 may be associated with a merchant and the data processing transaction may be a payment from the user to the merchant. Computing system 120 may be associated with a financial institution, such as a bank that maintains the financial account from which funds will be withdrawn in order to make the payment to the merchant. Entity 140 may comprise any suitable hardware and/or software. Examples include a workstation, a personal computer, a laptop, a tablet computer, a phone, a smartphone, a handheld device, a wireless device, a server, a data center, a virtual machine, a mainframe computer, etc.

In certain embodiments, system 100 may be used to facilitate payments from the user (e.g., via user device 110) to a merchant (e.g., via entity 140) by sending a payment request via computing system 120. In certain embodiments, prior to transacting a requested payment, computing system 120 determines whether the requested payment uses a pattern associated with unauthorized payments. If the computing system 120 determines that the requested payment uses a pattern associated with unauthorized payments, computing system 120 may block the payment such that funds are not transferred to entity 140.

As an example, a pattern associated with unauthorized payments may include using a made-up merchant name as an attribute of the payment. The made-up merchant names often show up as “smash key” characters. Smash key characters refer to random characters, such as characters that may be generated by randomly smashing a keyboard (unlike actual merchant names, which typically include recognizable/non-random combinations of characters, such as brand names, natural language words, etc.). In some cases, made-up merchant names may be generated by random character generators. Certain embodiments may detect patterns associated with the made-up merchant names in order to reverse-engineer the random character generators.

As an example, certain embodiments determine the pattern associated with made-up merchant names based on analyzing characteristics that known made-up merchant names frequently have in common with each other and rarely have in common with known legitimate merchant names. In certain embodiments, the known made-up merchant names may be determined from previous payments that were flagged as unauthorized, for example, based on suspicious behavior. As an example of suspicious behavior, a user that has obtained a payment card in an unauthorized manner may use the payment card to make a test payment (e.g., a payment that tests whether the payment card is active). The test payment may use a made-up merchant name. The user may make the test payment for a small purchase amount, for example, to avoid detection. If the test payment is successful, the user may attempt to use the payment card to make a second payment having a higher purchase amount (e.g., the user may seek to maximize the value derived from the payment card before the payment card can be blocked due to unauthorized use). The user may attempt the second payment soon after the test payment in order to try to complete the second payment before raising suspicion that may cause the second payment to be blocked as unauthorized. If computing system 120 detects a payment that appears to be a test payment (such as a payment for a small amount followed within a few minutes by a payment for a large amount, optionally in combination with other suspicious factors), computing system 120 may include the merchant name from the test payment as a known made-up merchant name. In certain embodiments, the known legitimate merchant names may merchant names for which the financial institution has established trust, for example, based on having transacted a relatively high volume of authorized transactions over a relatively long period of time (e.g., well-known brands).

As computing system 120 continues to receive new payment requests, computing system 120 may use the pattern to detect merchant names that appear to be made-up and may use that information (optionally, along with other factors) to determine whether to identify the new payment requests as unauthorized. In this manner, computing system 120 may identify and block unauthorized payment requests that use merchant names that computing system 120 might not have seen before, such as newly generated “smash key” merchant names, based on these merchant names using a pattern associated with previous unauthorized merchant names. Examples of other factors that may be used to assess a requested payment, such as merchant ID and/or merchant location, are further described with respect to FIG. 2.

For purposes of example and explanation, FIG. 1 depicts the network as including certain components. However, this disclosure recognizes that the network may include any suitable components. One of ordinary skill in the art will appreciate that certain components can be omitted and other components not mentioned herein can be added. Additionally, components can be integrated or separated in any suitable manner. Functionality described in FIG. 1 can be distributed or localized in any suitable manner.

FIG. 2 illustrates an example of a method 200 that may be performed by a computing system, such as the computing system 120 described with respect to FIG. 1. The method 200 begins at step 202 with obtaining historical data. The historical data is associated with a plurality of previous data processing transactions. The historical data for each of the plurality of previous data processing transactions comprising a set of attributes. Examples of attributes may include an entity name attribute, an entity identifier attribute, an entity location attribute, a timestamp attribute, a transaction amount attribute, a transaction account attribute, and/or other attributes. In an embodiment where the previous data processing transactions transact payments, the entity name attribute may comprise a merchant name, the entity identifier attribute may comprise a merchant identifier (e.g., string of random numbers and letters assigned to identify the merchant), the entity location attribute may comprise a zip code associated with the merchant, the timestamp attribute may comprise a time that the payment was requested, the transaction amount attribute may comprise a payment amount, and the transaction account attribute may comprise a source financial account or a destination financial account for the payment.

Method 200 may obtain the historical data from any suitable source. As an example, in certain embodiments, step 202 may be performed by a machine learning module 126 that obtains the historical data from repository 124 (which may include archived data, for example) and/or from data processing module 122 (for example, in connection with receiving requests to transact data processing transactions, data processing module 122 may communicate attributes of the data processing transactions to machine learning module 126).

Method 200 proceeds to step 204 with 204 classifying the previous data processing transactions for which the historical data was obtained in step 202. Certain embodiments classify each previous data processing transaction of the plurality of previous data processing transactions as either authorized or unauthorized. Thus, an authorized previous data processing transaction may be classified as a member of a group of authorized previous data processing transactions, while an unauthorized previous data processing transaction may be classified as a member of a group of unauthorized previous data processing transactions. Classification may be performed in any suitable manner, such as based on analyzing attributes of the previous data processing transactions or based on receiving indicators associated with the previous data processing transactions, each indicator indicating an authorized or unauthorized status of a respective previous data processing transactions.

In an embodiment where the previous data processing transactions transact payments, classifying the previous data processing transactions may be based at least in part on a transaction amount attribute. For example, a user that has obtained a payment card in an unauthorized manner may use the payment card to make a test payment (e.g., a payment that tests whether the payment card is active). The test payment may use a made-up merchant name as the entity name attribute. The user may make the test payment for a small purchase amount, for example, to avoid detection. If the test payment is successful, the user may attempt to use the payment card to make a second payment having a higher purchase amount (e.g., the user may seek to maximize the value derived from the payment card before the payment card can be blocked due to unauthorized use). The user may attempt the second payment soon after the test payment in order to try to complete the second payment before raising suspicion that may cause the second payment to be blocked as unauthorized.

Certain embodiments detect this test payment pattern of behavior and classify the test payment as unauthorized so that attributes of the test payment, such as the made-up merchant name, can be used to determine one or more patterns associated with unauthorized payments. For example, in certain embodiments, the previous data processing transactions comprise a first previous data processing transaction (e.g., test payment) associated with a first transaction amount (e.g., low amount) and a first timestamp. The previous data processing transactions also comprise a second previous data processing transaction associated with a second transaction amount (e.g., high amount) and a second timestamp. The first previous data processing transaction and the second previous data transaction are associated with the same transaction account attribute (e.g., both use the same payment card). In the embodiment, the method 200 classifies the first previous data processing transaction as one of the members of the group of unauthorized previous data processing transactions based at least in part on determining that the second timestamp follows the first timestamp within a pre-determined time period and the second transaction amount exceeds the first transaction amount by at least a pre-determined factor. As an example, the pre-determined time period may be on the order of a few seconds or a few minutes. In an embodiment, the second transaction amount may be determined to exceed the first transaction amount by at least the pre-determined factor if the first transaction amount is below a first threshold and the second transaction amount is above a second threshold (which may be the same or different than the first threshold). In another embodiment, the second transaction amount may be determined to exceed the first transaction amount by at least the pre-determined factor if the second transaction amount is greater than the first transaction amount multiplied by the pre-determined factor. As examples, the predetermined factor may be set to 10, 25, 50, 75, 100, 250, 500, 750, 1000, or other suitable value.

Method 200 may analyze the attributes used by the members of the group of unauthorized previous data processing transactions to determine one or more patterns associated with the unauthorized previous data processing transactions. In certain embodiments, method 200 determines a first pattern at step 206. The first pattern is associated with the entity name attributes used by the members of the group of unauthorized previous data processing transactions.

In certain embodiments, determining the first pattern may be based on one or more characteristics of the entity name attribute for which a recurrence rate is high with respect to the members of the group of unauthorized previous data processing transactions and the recurrence rate is low with respect to the members of the authorized previous data processing transactions. As an example, in the case where the entity name attributes are merchant names, suppose merchant names associated with unauthorized previous data processing transactions include names like “XHRNW . . . ,” “ZSKBL . . . ,” and “VQTJM . . . ,” whereas merchant names associated with authorized pervious data processing transactions include names like “Company A,” “Store B,” and “Vendor C.” In the example, the characteristic of having five consecutive consonants in the entity name attribute may be analyzed to determine whether the recurrence rate is high with respect to the members of the group of unauthorized previous data processing transactions and the recurrence rate is low with respect to the members of the authorized previous data processing transactions. Whether a recurrence rate is considered high or low may be determined in any suitable manner, such as based on a threshold (e.g., a recurrence rate above X % may be considered high, or a recurrence rate associated with the unauthorized set may be considered high if it is at least X % greater than a recurrence rate associated with the authorized set, or other threshold). In the example, method 200 may determine that the characteristic of having five consecutive consonants in the entity name attribute is high with respect to the members of the group of unauthorized previous data processing transactions (3 out of 3) and low with respect to the members of the authorized previous data processing transactions (0 out of 3). Thus, the first pattern may indicate that the characteristic of having five consecutive consonants in the entity name attribute increases the likelihood that the data processing transaction is unauthorized.

The method proceeds to step 208 with facilitating identifying a new data processing transaction as unauthorized based at least in part on an entity name attribute associated with the new data processing transaction using the first pattern. In certain embodiments, step 208 facilitates identifying the new data processing transaction as unauthorized by communicating the first pattern to a computing component that analyzes the attributes of the new data processing transaction to determine whether the attributes match the first pattern. In this manner, a first computing system or computing component may determine the pattern, and a second computing system or computing component may identify the unauthorized data processing transaction based on the pattern. In other embodiments, step 208 facilitates identifying the new data processing transaction as unauthorized by analyzing the attributes of the new data processing transaction to determine whether the attributes match the first pattern. In this manner, the same computing system or computing component may both determine the pattern and identify unauthorized data processing transactions. Certain embodiments block the new data processing transaction in response to identifying the new data processing transaction as unauthorized.

In certain embodiments, a determination of whether the new data processing transaction is unauthorized may depend on multiple attributes. Thus, certain embodiments may determine multiple patterns for multiple attributes that, when combined, indicate to identify the new data processing transaction as unauthorized. As an example, certain embodiments may determine whether the new data processing transaction is unauthorized based at least in part on the first pattern (the pattern determined using the entity name attributed) together with a second pattern (such as a pattern determined using the entity identifier attribute) and/or a third pattern (such as a pattern determined using the entity location attribute) and/or one or more other patterns.

In certain embodiments, method 200 determines a second pattern. The second pattern may be associated with the entity identifier attribute used by the members of the group of unauthorized previous data processing transactions. In the example where the entity identifier attributes are merchant IDs, if merchant IDs beginning with certain characters (such as “007” or “0051”) recur at an unusually high rate in the group of unauthorized previous data processing transactions, the second pattern may be configured to associate those characters with a higher likelihood of a data processing transaction being unauthorized. In step 208, facilitating identifying the new data processing transaction as unauthorized may be further based at least in part on an entity identifier attribute associated with the new data processing transaction using the second pattern.

In certain embodiments, method 200 determines a third pattern. The third pattern may be associated with the entity location attribute used by the members of the group of unauthorized previous data processing transactions. In the example where the entity identifier attributes are merchant zip codes, if certain merchant zip code characteristics recur at an unusually high rate in the group of unauthorized previous data processing transactions, the third pattern may be configured to associate those characters with a higher likelihood of a data processing transaction being unauthorized. As an example, if method 200 determines that authorized previous data processing transactions associated with the same merchant name and/or merchant ID typically use the same zip code, but unauthorized previous data processing transactions associated with the same merchant name and/or merchant ID typically use five or more different zip codes, method 200 may associate the pattern of using five or more different zip codes with a higher likelihood of a data processing transaction being unauthorized. In step 208, facilitating identifying the new data processing transaction as unauthorized may be further based at least in part on an entity location attribute associated with the new data processing transaction using the third pattern.

As noted above, certain embodiments may take one pattern into consideration when determining whether to identify the new data processing transaction as unauthorized. Other embodiments may take multiple patterns into consideration when determining whether to identify the new data processing transaction as unauthorized. Continuing with the previous example, certain embodiments may determine that simply using a merchant name comprising five consecutive consonants might not be sufficient to identify the new data processing transaction as unauthorized. However, in an embodiment, if method 200 determines that the new data processing transaction uses a merchant name comprising five consecutive consonants (i.e., the new data processing transaction uses the first pattern), that the merchant ID begins with “007” (i.e., the new data processing transaction uses the second pattern), and that the merchant name and/or merchant ID have been associated with five or more zip codes (i.e., the new data processing transaction uses the third pattern), then method 200 identifies the new data processing transaction as unauthorized.

Certain embodiments may repeat one or more steps of method 200, for example, in order to keep the patterns up-to-date so that unauthorized data processing transactions can be identified quickly and accurately. Suppose a user attempting unauthorized data processing transactions changes one or more attributes of the unauthorized data processing transactions over time, for example, in order to avoid detection or in response to computing system 120 blocking previous unauthorized data processing transactions associated with certain attributes. Changing the attributes may cause the patterns to change. In order to keep the patterns up-to-date, certain embodiments update the historical data based at least in part on the new data processing transaction of step 208 (and optionally based on other new data processing transactions) and then update one or more patterns (e.g., first pattern, second pattern, third pattern, etc.) based on the updated historical data.

FIG. 3 illustrates an example of computing components 300, in accordance with certain embodiments. The computing components 300 may be used to implement any of the structures illustrated in FIG. 1, or one or more portions thereof, such as network 105, user device 110, computing system 120, and/or entity 140. The computing components 300 may comprise any suitable hardware and/or software configured to perform the functionality described above. The computing components 300 may be implemented using shared hardware or separate hardware. In certain embodiments, computing components 300 may be distributed in a cloud network environment.

In certain embodiments, the components comprise one or more interface(s) 302, processing circuitry 304, and/or memory(ies) 306. In general, processing circuitry 304 controls the operation and administration of a structure by processing information received from memory 306 and/or interface 302. Memory 306 stores, either permanently or temporarily, data or other information processed by processing circuitry 304 or received from interface 302. Interface 302 receives input, sends output, processes the input and/or output and/or performs other suitable operations. An interface 302 may comprise hardware and/or software.

Examples of interfaces 302 include user interfaces, network interfaces, and internal interfaces. Examples of user interfaces include one or more graphical user interfaces (GUIs), buttons, microphones, speakers, cameras, and so on. Network interfaces receive information from or transmit information through a network, perform processing of information, communicate with other devices, or any combination of the preceding. Network interfaces may comprise any port or connection, real or virtual, wired or wireless, including any suitable hardware and/or software, including protocol conversion and data processing capabilities, to communicate through a LAN, WAN, or other communication system that allows processing circuitry 304 to exchange information with or through a network. Internal interfaces receive and transmit information among internal components of a structure.

Processing circuitry 304 communicatively couples to interface(s) 302 and memory 306, and includes any hardware and/or software that operates to control and process information. Processing circuitry 304 may include a programmable logic device, a microcontroller, a microprocessor, any suitable processing device, or any suitable combination of the preceding. Processing circuitry 304 may execute logic stored in memory 306. The logic is configured to perform functionality described herein. In certain embodiments, the logic is configured to perform the method described with respect to FIG. 2.

Memory 306 includes any one or a combination of volatile or non-volatile local or remote devices suitable for storing information. For example, memory comprises any suitable non-transitory computer readable medium, such as Read Only Memory (“ROM”), Random Access Memory (“RAM”), magnetic storage devices, optical storage devices, or any other suitable information storage device or a combination of these devices. Memory 306 may be local/integrated with the hardware used by processing circuitry 304 and/or remote/external to the hardware used by processing circuitry 304.

The scope of this disclosure is not limited to the example embodiments described or illustrated herein. The scope of this disclosure encompasses all changes, substitutions, variations, alterations, and modifications to the example embodiments described or illustrated herein that a person having ordinary skill in the art would comprehend.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic.

Modifications, additions, or omissions may be made to the methods described herein without departing from the scope of the disclosure. The methods may include more, fewer, or other steps. Additionally, steps may be performed in any suitable order. That is, the steps of any method disclosed herein do not have to be performed in the exact order disclosed, unless explicitly stated.

As used in this document, “each” refers to each member of a set or each member of a subset of a set. Furthermore, as used in the document “or” is not necessarily exclusive and, unless expressly indicated otherwise, can be inclusive in certain embodiments and can be understood to mean “and/or.” Similarly, as used in this document “and” is not necessarily inclusive and, unless expressly indicated otherwise, can be inclusive in certain embodiments and can be understood to mean “and/or.” All references to “a/an/the element, apparatus, component, means, step, etc.” are to be interpreted openly as referring to at least one instance of the element, apparatus, component, means, step, etc., unless explicitly stated otherwise.

Furthermore, reference to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Although several embodiments have been illustrated and described in detail, it will be recognized that substitutions and alterations are possible without departing from the spirit and scope of the present disclosure, as defined by the appended claims.

1. A system, the system comprising:
a memory operable to store historical data associated with a plurality of previous data processing transactions, the historical data for each of the plurality of previous data processing transactions comprising a set of attributes, the set of attributes comprising an entity name attribute; and
a processor operably coupled to the memory, the processor configured to:
obtain the historical data;
for each previous data processing transaction of the plurality of previous data processing transactions, classify the previous data processing transaction as a member of a group of unauthorized previous data processing transactions or as a member of a group of authorized previous data processing transactions;
determine a first pattern, the first pattern associated with the entity name attributes used by the members of the group of unauthorized previous data processing transactions; and
facilitate identifying a new data processing transaction as unauthorized based at least in part on an entity name attribute associated with the new data processing transaction using the first pattern.

2. The system of claim 1, wherein the set of attributes further comprises an entity identifier attribute and the processor is further configured to:
determine a second pattern, the second pattern associated with the entity identifier attribute used by the members of the group of unauthorized previous data processing transactions; and
facilitate identifying the new data processing transaction as unauthorized based at least in part on an entity identifier attribute associated with the new data processing transaction using the second pattern.

3. The system of claim 1, wherein the set of attributes further comprises an entity location attribute and the processor is further configured to:
determine a third pattern, the third pattern associated with the entity location attribute used by the members of the group of unauthorized previous data processing transactions; and
facilitate identifying the new data processing transaction as unauthorized based at least in part on an entity location attribute associated with the new data processing transaction using the third pattern.

4. The system of claim 1, wherein to determine the first pattern, the processor is configured to:
determine the first pattern based on one or more characteristics of the entity name attributes for which a recurrence rate is high with respect to the members of the group of unauthorized previous data processing transactions and the recurrence rate is low with respect to the members of the authorized previous data processing transactions.

5. The system of claim 1, wherein the processor is further configured to block the new data processing transaction in response to identifying the new data processing transaction as unauthorized.

6. The system of claim 1, wherein the processor is further configured to:
update the historical data based at least in part on the new data processing transaction; and
update the first pattern based on the updated historical data.

7. The system of claim 1, wherein:
the previous data processing transactions comprise:
a first previous data processing transaction associated with a first transaction account, a first transaction amount, and a first timestamp; and
a second previous data processing transaction associated with the first transaction account, a second transaction amount, and a second timestamp; and
the processor is further configured to classify the first previous data processing transaction as one of the members of the group of unauthorized previous data processing transactions based at least in part on determining that the second timestamp follows the first timestamp within a pre-determined time period and the second transaction amount exceeds the first transaction amount by at least a pre-determined factor.

8. A method, the method comprising:
obtaining historical data associated with a plurality of previous data processing transactions, the historical data for each of the plurality of previous data processing transactions comprising a set of attributes, the set of attributes comprising an entity name attribute;
for each previous data processing transaction of the plurality of previous data processing transactions, classifying the previous data processing transaction as a member of a group of unauthorized previous data processing transactions or as a member of a group of authorized previous data processing transactions;
determining a first pattern, the first pattern associated with the entity name attributes used by the members of the group of unauthorized previous data processing transactions; and
facilitating identifying a new data processing transaction as unauthorized based at least in part on an entity name attribute associated with the new data processing transaction using the first pattern.

9. The method of claim 8, wherein the set of attributes further comprises an entity identifier attribute and the method further comprises:
determining a second pattern, the second pattern associated with the entity identifier attribute used by the members of the group of unauthorized previous data processing transactions; and
facilitating identifying the new data processing transaction as unauthorized based at least in part on an entity identifier attribute associated with the new data processing transaction using the second pattern.

10. The method of claim 8, wherein the set of attributes further comprises an entity location attribute and the method further comprises:
determining a third pattern, the third pattern associated with the entity location attribute used by the members of the group of unauthorized previous data processing transactions; and
facilitating identifying the new data processing transaction as unauthorized based at least in part on an entity location attribute associated with the new data processing transaction using the third pattern.

11. The method of claim 8, wherein to determine the first pattern, the method comprises:
determining the first pattern based on one or more characteristics of the entity name attributes for which a recurrence rate is high with respect to the members of the group of unauthorized previous data processing transactions and the recurrence rate is low with respect to the members of the authorized previous data processing transactions.

12. The method of claim 8, further comprising:
blocking the new data processing transaction in response to identifying the new data processing transaction as unauthorized.

13. The method of claim 8, further comprising:
updating the historical data based at least in part on the new data processing transaction; and
updating the first pattern based on the updated historical data.

14. The method of claim 8, wherein:
the previous data processing transactions comprise:
a first previous data processing transaction associated with a first transaction account, a first transaction amount, and a first timestamp; and
a second previous data processing transaction associated with the first transaction account, a second transaction amount, and a second timestamp; and
the method further comprises classifying the first previous data processing transaction as one of the members of the group of unauthorized previous data processing transactions based at least in part on determining that the second timestamp follows the first timestamp within a pre-determined time period and the second transaction amount exceeds the first transaction amount by at least a pre-determined factor.

15. A non-transitory computer readable medium comprising logic that, when executed by processing circuitry, causes the processing circuitry to perform actions comprising:
obtaining historical data associated with a plurality of previous data processing transactions, the historical data for each of the plurality of previous data processing transactions comprising a set of attributes, the set of attributes comprising an entity name attribute;
for each previous data processing transaction of the plurality of previous data processing transactions, classifying the previous data processing transaction as a member of a group of unauthorized previous data processing transactions or as a member of a group of authorized previous data processing transactions;
determining a first pattern, the first pattern associated with the entity name attributes used by the members of the group of unauthorized previous data processing transactions; and
facilitating identifying a new data processing transaction as unauthorized based at least in part on an entity name attribute associated with the new data processing transaction using the first pattern.

16. The non-transitory computer readable medium of claim 15, wherein the set of attributes further comprises an entity identifier attribute and the actions further comprise:
determining a second pattern, the second pattern associated with the entity identifier attribute used by the members of the group of unauthorized previous data processing transactions; and
facilitating identifying the new data processing transaction as unauthorized based at least in part on an entity identifier attribute associated with the new data processing transaction using the second pattern.

17. The non-transitory computer readable medium of claim 15, wherein the set of attributes further comprises an entity location attribute and the actions further comprise:
determining a third pattern, the third pattern associated with the entity location attribute used by the members of the group of unauthorized previous data processing transactions; and
facilitating identifying the new data processing transaction as unauthorized based at least in part on an entity location attribute associated with the new data processing transaction using the third pattern.

18. The non-transitory computer readable medium of claim 15, wherein to determine the first pattern, the actions comprise:
determining the first pattern based on one or more characteristics of the entity name attributes for which a recurrence rate is high with respect to the members of the group of unauthorized previous data processing transactions and the recurrence rate is low with respect to the members of the authorized previous data processing transactions.

19. The non-transitory computer readable medium of claim 15, wherein the actions further comprise blocking the new data processing transaction in response to identifying the new data processing transaction as unauthorized.

20. The non-transitory computer readable medium of claim 15, wherein the actions further comprise:
updating the historical data based at least in part on the new data processing transaction; and
updating the first pattern based on the updated historical data.
